(19) United States
(12) Patent Application Publication
(10) Pub. No.: US 2021/0015101 A1
(43) Pub. Date: Jan. 21, 2021

(54) Method For Treating Plants With Hypochlorous Water

(71) Applicant: Mark D. Noar, Owings Mills, MD (US)

(72) Inventor: Mark D. Noar, Owings Mills, MD (US)

(21) Appl. No.: 16/922,022

(22) Filed: Jul. 7, 2020

Related U.S. Application Data
(60) Provisional application No. 62/874,617, filed on Jul. 16, 2019.

(51) Int. Cl. A01N 59/00; A01N 25/02

(52) U.S. Cl. CPC A01N 59/00; A01N 25/02

(57) ABSTRACT

A method treats a consumable or non-consumable plant to reduce or eliminate bacterial, viruses, and fungi on the plant. The method sprays hypochlorous water onto a growing plant. At least a portion of the sprayed plant is harvested. The harvested portion of the plant is exposed to hypochlorous water. The hypochlorous water exposed portion of the plant is permitted to dry. A product prepared by the above process is also provided.

### BACKGROUND

Consumable plants such as Cannabis sativa (hereinafter “cannabis”) and tobacco are susceptible to bacteria, fungus such as mold and viruses and thus to insects that feed thereon. Growers of such plants typically employ industrial fungicides and insecticides in an effort to kill the bacterial, viruses, fungus and the insects infecting the crop. However, these chemicals are not organic they can have detrimental impact to the environment and may also introduce toxins into the plant.

Thus, there is a need to treat consumable and non-consumable plants with hypochlorous water to protect them from bacteria, viruses, fungus and insects, without releasing toxic or noxious residues.

### SUMMARY

An objective of the embodiment is to fulfill the need referred to above. In accordance with the embodiment, a method treats a plant to reduce or eliminate bacterial, viruses, and fungi on the plant. The method sprays hypochlorous water onto a growing plant. At least a portion of the sprayed plant is harvested. The harvested portion of the plant is exposed to hypochlorous water. The hypochlorous water exposed portion of the plant is permitted to dry.

Other objectives, features and characteristics of the present embodiment, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawing, wherein like reference numerals refer to like parts, in which:

FIG. 1 is a flowchart of the steps of a method in accordance with an embodiment.

FIG. 2 is flowchart of the steps of a method in accordance with a second embodiment.

### DETAILED DESCRIPTION OF EXAMPLE EMBODIMENTS

The present invention relates to a method for treating consumable plants such as, for example, cannabis, tobacco, fruit plants, vegetable plants, or any other plant which, at least portions thereof, are suitable to be consumed by humans or animals. The present invention is also applicable to non-consumable plants such as flowering plants (flowers).

Hypochlorous acid water (hereinafter, HOCl water or hypochlorous water), also known as electrolyzed water, is a known organic disinfectant and is typically used on surfaces in restrooms and hospitals. However, if used as a disinfectant on plants, the HOCl water would kill the plant in such concentration. Applicant found that the use of HOCl water with a chlorine concentration in the range of 5 ppm to 100 ppm and with a PH preferably in a range between 5 and 8 can be provided on consumable plants, such as cannabis, to kill fungus, bacteria, viruses and certain insects thereon, without damaging the plant.

In one embodiment, to ensure complete coverage of the HOCl water on the plant, a conventional electrostatic sprayer charges the HOCl water droplets emanating there-from to enable a quick and effective application to the plant. The droplets are negatively-charged upon leaving the sprayer and are then attracted to the positively charged plant surface. These droplets can change direction and move upwards against gravity to coat all of the plant surfaces. Thus, both the upper and underside of leaves of the plants are covered along with the stems with the HOCl water. The sprayers can be fixed, portable or mounted on a vehicle. It can be appreciated that the plant can be spayed with HOCl water with a conventional, non-electrostatic, sprayer.

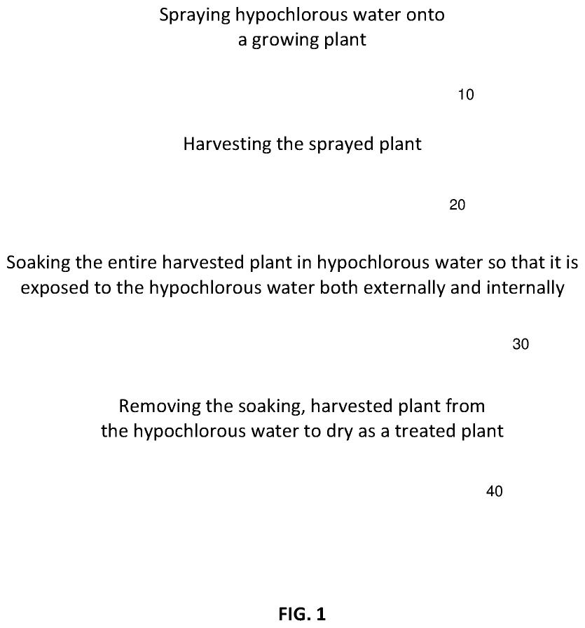

With reference to FIG. 1, a method of treating a consumable or non-consumable plant with HOCl water will be appreciated. In step 10, HOCl water is sprayed onto a growing plant. Spraying can include delivering a fog or a mist and can be from a conventional or electrostatic sprayer. In step 20, the growing and spray-treated plant is harvested (e.g., cannabis, tobacco). In step 30, for systemic treatment, the entire harvested plant is soaked in HOCl water so that the harvested plant is exposed to the HOCl water both externally and internally to control or prevent disease in the plant. For internal treatment, the HOCl water can enter the stem of the plant by capillary action and/or may be absorbed by leaves of the plant. In step 40, the soaking, harvested plant is then removed from the HOCl water to dry as a treated plant. If the plant is consumable, the treated consumable plant is then processed for consumption.

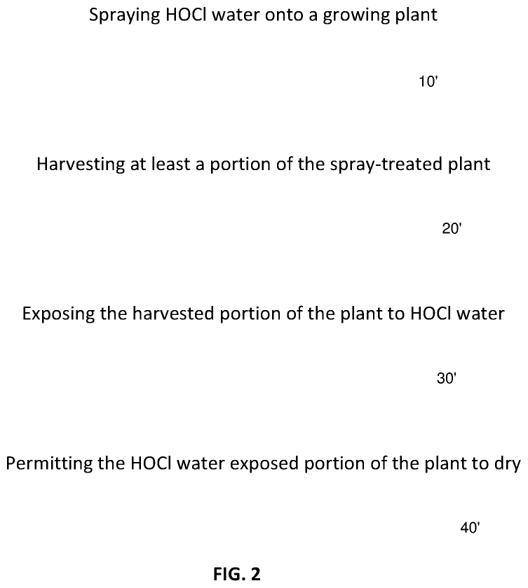

FIG. 2 is a flowchart of the steps of another embodiment of the method wherein the plant is a fruit plant, a vegetable plant or a flower plant and wherein only portion of the plant is harvested. In step 10′, HOCl water is sprayed onto a growing plant. Spraying can include delivering a fog or a mist and can be from a conventional or electrostatic sprayer. In step 20′, at least a portion of the spray-treated plant is harvested (e.g., fruit, vegetable, flower). In step 30′, the harvested portion of the plant is exposed to HOCl water, such as externally. In step 40′, the HOCl water exposed portion of the plant is permitted to dry. If the portion of the plant is consumable, it is then processed for consumption.

Since the HOCl water is organic and naturally occurs in the human body, it has not been found to cause hazard to human health. In addition to treating the plant or portion thereof, the method can also include spraying preferably electrically charged HOCl water droplets onto surfaces, tools, packing facilities or materials or other environmental surfaces or enclosures that will come in contact with the treated plant.

Thus, the use of HOCl water in the chlorine concentration and pH ranges noted above protects a plant from bacteria, viruses, fungus and insects, without releasing toxic or noxious residues. Advantageously, the treated plant remains 100% organic since no non-organic chemical fungicides or insecticides have been used on the plant.

Since the HOCl water has a relatively short shelf-life, preferably the HOCl water is generated at the site of use, by, for example, electrolyzing a solution of alkali chlorides.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A method of treating a plant to reduce or eliminate bacterial, viruses, and fungi on the plant, the method comprising the steps of:
spraying hypochlorous water onto a growing plant;
harvesting at least a portion of the sprayed plant;
exposing the harvested portion of the plant to hypochlorous water; and
permitting the hypochlorous water exposed, harvested portion of the plant to dry.

2. The method of claim 1, wherein the plant is a consumable plant so as that at least a portion thereof is suitable to being consumed by a human or animal.

3. The method of claim 1, wherein the spraying step comprises:
spraying electrically charged hypochlorous water droplets.

4. The method of claim 2, wherein the exposing step comprises:
soaking the entire harvested plant in the hypochlorous water so as to that the plant is exposed to the hypochlorous water both externally and internally.

5. The method of claim 4, further comprising, after permitting the harvested portion of the plant to dry:
processing the harvested portion of the consumable plant for consumption.

6. The method of claim 1, further comprising:
spraying hypochlorous water onto surfaces, tools, packing facilities, and materials that may come in contact with the plant.

7. The method of claim 4, wherein the consumable plant is Cannabis sativa.

8. The method of claim 4, wherein the consumable plant is tobacco.

9. The method of claim 2, wherein the consumable plant is a fruit plant or a vegetable plant and the harvested portion is a fruit or a vegetable.

10. The method of claim 1, wherein the plant is a flowering plant and the harvested portion is a flower.

11. The method of claim 1, wherein a chlorine concentration in the hypochlorous water is in the range of 5 ppm to 100 ppm and the pH of the hypochlorous water is in a range of 5 to 8.

12. A plant with reduced or eliminate bacterial, viruses, and fungi on the plant prepared by a process comprising the steps of:
spraying hypochlorous water onto a growing plant;
harvesting at least a portion of the sprayed plant;
exposing the harvested portion of the plant to hypochlorous water; and
permitting the hypochlorous water exposed, harvested portion of the plant to dry.

13. The plant of claim 12, wherein the spraying includes:
spraying electrically charged hypochlorous water droplets.

14. The plant of claim 12, wherein the plant is a consumable plant so as that at least a portion thereof is suitable to being consumed by a human or animal.

15. The method of claim 14, wherein the exposing step comprises:
soaking the entire harvested plant in the hypochlorous water so as to that the plant is exposed to the hypochlorous water both externally and internally.

16. The plant of claim 15, wherein the consumable plant is Cannabis sativa or tobacco.

17. The plant of claim 14, wherein the consumable plant is a fruit plant or a vegetable plant and the harvested portion is a fruit or a vegetable.

18. The plant of claim 12, wherein the plant is a flowering plant and the harvested portion is a flower.

19. The plant of claim 12, wherein a chlorine concentration in the hypochlorous water is in the range of 5 ppm to 100 ppm and the pH of the hypochlorous water is in a range of 5 to 8.
